(19) United States
(12) Patent Application Publication
(10) Pub. No.: US 2025/0149634 A1
(43) Pub. Date: May 8, 2025

(54) LITHIUM-ION BATTERY

(71) Applicant: TOYOTA JIDOSHA KABUSHIKI KAISHA, Aichi-ken (JP)

(72) Inventor: Kazuya TAKEUCHI, Shizuoka-ken (JP)

(21) Appl. No.: 18/925,028

(22) Filed: Oct. 24, 2024

(30) Foreign Application Priority Data
Nov. 2, 2023 (JP) 2023-188896
Jun. 12, 2024 (JP) 2024-095094

(51) Int. Cl. H01M 10/0568; H01M 4/66; H01M 10/0525; H01M 10/0569

(52) U.S. Cl. CPC H01M 10/0568; H01M 4/661; H01M 4/667; H01M 10/0525; H01M 10/0569; H01M 2300/0028

(57) ABSTRACT

Disclosed is a lithium-ion battery in which elution of aluminum from an aluminum-containing current collector into an electrolyte solution is suppressed. The lithium-ion battery of the present disclosure comprises a positive electrode, a negative electrode, and an electrolyte solution, wherein the electrolyte solution comprises an organic solvent and a lithium amide salt dissolved in the organic solvent, the lithium amide salt comprises LiCFSA, one or both of the positive electrode and the negative electrode comprise an aluminum-containing current collector, the aluminum-containing current collector comprises, on a surface in contact with the electrolyte solution, a film, and the film comprises Al(CFSA)ₓ.

### FIELD

The present application discloses a lithium-ion battery.

### BACKGROUND

PTL 1 discloses an electrolyte solution for an electricity storage device comprising a cyclic lithium sulfonylimide salt, a hydrofluoroether, and a carbonate-based solvent. In addition, a lithium-ion secondary battery is exemplified as the electricity storage device in PTL 1. PTL 2 discloses a nonaqueous electrolyte solution comprising a carboxylate ester. PTL 3 discloses an electrolyte solution for a lithium-ion secondary battery containing a lithium imide salt, at least one solvent among carbonates, esters, ethers, and room-temperature molten salts, and at least one element among Group 1 elements and Group 2 elements.

### CITATION LIST

### Patent Literature

[PTL 1] WO 2010/110388
[PTL 2] Japanese Unexamined Patent Publication No. 2009-129719
[PTL 3] Japanese Unexamined Patent Publication No. 2019-096463

### SUMMARY

### Technical Problem

In order to effectively utilize an aluminum-containing current collector in a lithium-ion battery, it is necessary to suppress elution of aluminum from the aluminum-containing current collector into an electrolyte solution. The present application discloses a technique capable of suppressing elution of aluminum from an aluminum-containing current collector into an electrolyte solution in a lithium-ion battery.

### Solution to Problem

The present application discloses the following plurality of aspects as means for achieving the above object.

### Aspect 1

A lithium-ion battery, comprising a positive electrode, a negative electrode, and an electrolyte solution, wherein
the electrolyte solution comprises
   an organic solvent and
   a lithium amide salt dissolved in the organic solvent,
   the lithium amide salt comprises LiCFSA represented by formula (1) below,
one or both of the positive electrode and the negative electrode comprise an aluminum-containing current collector,
   the aluminum-containing current collector comprises, on a surface in contact with the electrolyte solution, a film, and
      the film comprises Al(CFSA)ₓ.

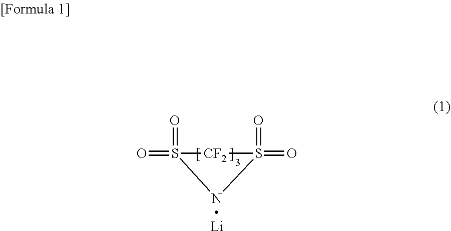

### Aspect 2

The lithium-ion battery according to Aspect 1, wherein
the electrolyte solution comprises sulfolane as the organic solvent.

### Aspect 3

The lithium-ion battery according to Aspect 1 or 2, wherein
the electrolyte solution comprises a carboxylate ester as the organic solvent.

### Aspect 4

The lithium-ion battery according to any of Aspects 1 to 3, wherein
the film comprises aluminum fluoride.

### Aspect 5

The lithium-ion battery according to any of Aspects 1 to 4, wherein
at least the positive electrode comprises the aluminum-containing current collector.

### Effects

According to the lithium-ion battery of the present disclosure, elution of aluminum from an aluminum-containing current collector into an electrolyte solution can be suppressed.

### BRIEF DESCRIPTION OF DRAWINGS

FIG. 1 schematically shows one example of a configuration of the lithium-ion battery.

FIG. 2 shows results of Al corrosion evaluation of Comparative Example 1.

FIG. 3 shows results of Al corrosion evaluation of Comparative Example 2.

FIG. 4 shows results of Al corrosion evaluation of Comparative Example 3.

FIG. 5 shows results of Al corrosion evaluation of Comparative Example 4.

FIG. 6 shows results of Al corrosion evaluation of Comparative Example 5.

FIG. 7 shows results of Al corrosion evaluation of Example 1.

FIG. 8 shows results of Al corrosion evaluation of Example 2.

FIG. 9 shows results of Al corrosion evaluation of Example 3.

FIG. 10 shows XPS analysis results (XPS spectrum for Al2p) of a film formed on a surface of an aluminum-containing current collector at 4 V.

FIG. 11 shows XPS analysis results (XPS spectrum for F1s) of a film formed on a surface of an aluminum-containing current collector at 4 V.

FIG. 12 shows XPS analysis results (XPS spectrum for S2p) of a film formed on a surface of an aluminum-containing current collector at 4 V.

FIG. 13 shows XPS analysis results (XPS spectrum for Al2p) of a film formed on a surface of an aluminum-containing current collector at 6 V.

FIG. 14 shows XPS analysis results (XPS spectrum for F1s) of a film formed on a surface of an aluminum-containing current collector at 6 V.

FIG. 15 shows XPS analysis results (XPS spectrum for S2p) of a film formed on a surface of an aluminum-containing current collector at 6 V.

### DESCRIPTION OF EMBODIMENTS

Hereinafter, one embodiment of the lithium-ion battery of the present disclosure will be described. However, the lithium-ion battery of the present disclosure is not limited to the embodiment described below.

### 1. Lithium-Ion Battery

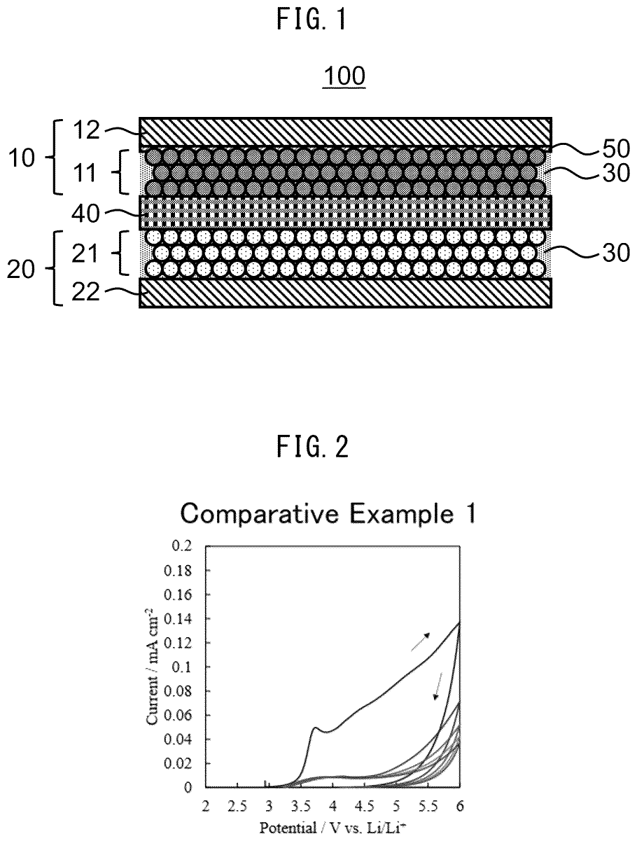

As shown in FIG. 1, the lithium-ion battery 100 according to one embodiment comprises a positive electrode 10, a negative electrode 20, and an electrolyte solution 30. The electrolyte solution 30 comprises an organic solvent and a lithium amide salt dissolved in the organic solvent. The lithium amide salt comprises LiCFSA represented by formula (1) below. One or both of the positive electrode 10 and the negative electrode 20 comprise an aluminum-containing current collector. The aluminum-containing current collector comprises, on a surface in contact with the electrolyte solution 30, a film 50. The film 50 comprises Al(CFSA)ₓ.

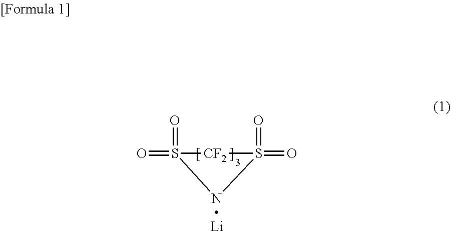

### 1.1 Positive Electrode

As shown in FIG. 1, the positive electrode 10 according to one embodiment can comprise a positive electrode active material layer 11 and a positive electrode current collector 12. When the negative electrode current collector 22 described below is an aluminum-containing current collector, the positive electrode current collector 12 may be an aluminum-containing current collector, or may not be an aluminum-containing current collector. When the negative electrode current collector 22 described below is not an aluminum-containing current collector, the positive electrode current collector 12 is an aluminum-containing current collector. Particularly, elution of aluminum from an aluminum-containing current collector into an electrolyte solution is likely to occur when the aluminum-containing current collector is at a high electric potential. However, according to the technique of the present disclosure, the elution of aluminum into the electrolyte solution 30 can be suppressed when at least the positive electrode 10 comprises an aluminum-containing current collector.

### 1.1.1 Positive Electrode Active Material Layer

The positive electrode active material layer 11 comprises a positive electrode active material and may further optionally comprise an electrolyte, a conductive aid, a binder, and various additives. The content of each of the positive electrode active material, electrolyte, conductive aid, and binder in the positive electrode active material layer 11 needs only to be appropriately determined in accordance with target battery performance. For example, when the entire positive electrode active material layer 11 (entire solid content) is 100% by mass, the content of the positive electrode active material may be 40% by mass or greater, 50% by mass or greater, or 60% by mass or greater, and may be less than 100% by mass or 90% by mass or less. The shape of the positive electrode active material layer 11 is not particularly limited, and for example, may be a sheet having a substantially flat surface. The thickness of the positive electrode active material layer 11 is not particularly limited, and for example, may be 0.1 μm or more, 1 μm or more, 10 μm or more, or 30 μm or more, and may be 2 mm or less, 1 mm or less, 500 μm or less, or 100 μm or less.

For the positive electrode active material, any known positive electrode active material for lithium-ion batteries can be adopted. Of known active materials, materials having a high electric potential (charge and discharge potentials) for storing and releasing lithium ions compared to the negative electrode active material described below can be used as the positive electrode active material. For example, as the positive electrode active material, various lithium-containing composite oxides such as lithium cobaltate, lithium nickelate, lithium manganate, lithium manganese-nickel-cobalt oxide, and spinel-based lithium compounds can be adopted. The positive electrode active material may be of one type used alone, or may be of two or more types used in combination. The positive electrode active material may be particulate, and the size thereof is not particularly limited. The particles of the positive electrode active material may be solid particles, or may be hollow particles. The particles of the positive electrode active material may be primary particles, or may be secondary particles of a plurality of agglomerated primary particles. The average particle size (D50) of the positive electrode active material particles, for example, may be 1 nm or more, 5 nm or more, or 10 nm or more, and may be 500 μm or less, 100 μm or less, 50 μm or less, or 30 μm or less. Note that the average particle size (D50) is the 50% cumulative particle size (D50, median diameter) in a volume-based particle size distribution determined by a laser diffraction/scattering method.

The surface of the positive electrode active material may be covered with a protective layer containing a lithium-ion conducting oxide. Specifically, the positive electrode active material layer 11 may comprise a composite comprising the above positive electrode active material and a protective layer provided on the surface thereof. Examples of the lithium-ion conducting oxide include Li₃BO₃, LiBO₂, Li₂CO₃, LiAlO₂, Li₄SiO₄, Li₂SiO₃, Li₃PO₄, Li₂SO₄, Li₂TiO₃, Li₄Ti₅O₁₂, Li₂Ti₂O₅, Li₂ZrO₃, LiNbO₃, Li₂MoO₄, and Li₂WO₄. The coverage (area ratio) of the protective layer, for example, may be 70% or greater, may be 80% or greater, or may be 90% or greater. The thickness of the protective layer, for example, may be 0.1 nm or more or 1 nm or more, and may be 100 nm or less or 20 nm or less.

The positive electrode active material layer 11 can comprise the electrolyte solution 30 described below. The positive electrode active material layer 11, in addition to the electrolyte solution 30, may comprise an additional electrolyte. The additional electrolyte may be a solid electrolyte, may be an electrolyte solution other than the electrolyte solution 30, or may be a combination thereof. The solid electrolyte needs only to be a known solid electrolyte for lithium-ion batteries. The solid electrolyte may be an inorganic solid electrolyte, or may be an organic polymer electrolyte. Particularly, inorganic solid electrolytes have excellent ion-conducting properties and heat resistance. Sulfide solid electrolytes and oxide solid electrolytes can be exemplified as the inorganic solid electrolyte. Particularly, among sulfide solid electrolytes, sulfide solid electrolytes comprising, as constituent elements, at least Li, S, and P have high performance, and sulfide solid electrolytes based on a Li₃PS₄ framework and comprising at least one or more halogens also have high performance. The solid electrolyte may be amorphous, or may be crystalline. The solid electrolyte, for example, may be particulate. The solid electrolyte may be of one type used alone, or may be of two or more types used in combination. The electrolyte solution other than the electrolyte solution 30 (additional electrolyte solution), for example, can comprise lithium ions as carrier ions. The additional electrolyte solution, for example, may be a non-water-based electrolyte solution. For example, as the additional electrolyte solution, an electrolyte solution having a lithium salt dissolved in a carbonate-based solvent at a predetermined concentration can be used.

Examples of the conductive aid that can be contained in the positive electrode active material layer 11 include carbon materials such as vapor-grown carbon fiber (VGCF), acetylene black (AB), ketjen black (KB), carbon nanotube (CNT), and carbon nanofiber (CNF); and metal materials such as nickel, aluminum, and stainless steel. The conductive aid, for example, may be particulate or fibrous, and the size thereof is not particularly limited. The conductive aid may be of one type used alone, or may be of two or more types used in combination.

Examples of the binder that can be contained in the positive electrode active material layer 11 include butadiene rubber (BR)-based binders, butylene rubber (IIR)-based binders, acrylate-butadiene rubber (ABR)-based binders, styrene-butadiene rubber (SBR)-based binders, polyvinylidene fluoride (PVdF)-based binders, polytetrafluoroethylene (PTFE)-based binders, polyimide (PI)-based binders, and polyacrylic acid-based binders. The binder may be of one type used alone, or may be of two or more types used in combination.

### 1.1.2 Positive Electrode Current Collector

As shown in FIG. 1, the positive electrode 10 may comprise a positive electrode current collector 12 in contact with the positive electrode active material layer 11 and the electrolyte solution 30. For the positive electrode current collector 12, any general positive electrode current collector for lithium-ion batteries can be adopted. The positive electrode current collector 12 may be foil-like, tabular, mesh-like, punched metal-like, or a foam. The positive electrode current collector 12 may be composed of a metal foil or a metal mesh. Particularly, a metal foil has excellent handleability. The positive electrode current collector 12 may consist of a plurality of foils. Metals constituting the positive electrode current collector 12 include Cu, Ni, Cr, Au, Pt, Ag, Al, Fe, Ti, Zn, Co, and stainless steel. As described above, the positive electrode 10 may comprise, as a positive electrode current collector 12, an aluminum-containing current collector in contact with the positive electrode active material layer 11 and the electrolyte solution 30. In this case, oxidation resistance is likely to be ensured. The positive electrode current collector 12 may comprise, on the surface thereof, some coating layer for the purpose of adjusting resistance. The positive electrode current collector 12 may be a metal foil or substrate plated or vapor-deposited with a metal described above. When the positive electrode current collector 12 consists of a plurality of metal foils, there may be some layer between the plurality of metal foils. The thickness of the positive electrode current collector 12 is not particularly limited, and for example, may be 0.1 μm or more or 1 μm or more, and may be 1 mm or less or 100 μm or less.

The positive electrode 10, in addition to the above configurations, may comprise any general configuration as a positive electrode for lithium-ion batteries, for example, tabs or terminals. The positive electrode 10 can be manufactured by applying a known method. For example, the positive electrode active material layer 11 can be easily formed by molding a positive electrode mixture comprising the above components in a dry method or a wet method. The positive electrode active material layer 11 may be molded with the positive electrode current collector 12, or may be molded separately from the positive electrode current collector 12.

### 1.2 Negative Electrode

As shown in FIG. 1, the negative electrode 20 according to one embodiment may comprise a negative electrode active material layer 21 and a negative electrode current collector 22. When the above positive electrode current collector 12 is an aluminum-containing current collector, the negative electrode current collector 22 may be an aluminum-containing current collector, or may not be an aluminum-containing current collector. When the above positive electrode current collector 12 is not an aluminum-containing current collector, the negative electrode current collector 22 is an aluminum-containing current collector.

### 1.2.1 Negative Electrode Active Material Layer

The negative electrode active material layer 21 comprises a negative electrode active material, and may optionally comprise an electrolyte, a conductive aid, a binder, and various additives. The content of each of the negative electrode active material, electrolyte, conductive aid, and binder in the negative electrode active material layer 21 needs only to be appropriately determined in accordance with the target battery performance. For example, when the entire negative electrode active material layer 21 (entire solid content) is 100% by mass, the content of the negative electrode active material may be 40% by mass or greater, 50% by mass or greater, or 60% by mass or greater, and may be less than 100% by mass or 90% by mass or less. The shape of the negative electrode active material layer 21 is not particularly limited, and for example, may be a sheet having a substantially flat surface. The thickness of the negative electrode active material layer 21 is not particularly limited, and for example, may be 0.1 μm or more, 1 μm or more, 10 μm or more, or 30 μm or more, and may be 2 mm or less, 1 mm or less, 500 μm or less, or 100 μm or less.

For the negative electrode active material, any known negative electrode active material for lithium-ion batteries can be adopted. Of known active materials, materials having a low electric potential (charge and discharge potentials) for storing and releasing lithium ions compared to the above positive electrode active material can be used as the negative electrode active material. For example, as the negative electrode active material, silicon-based active materials such as Si, Si alloys, and silicon oxides; carbon-based active materials such as graphite and hard carbon; various oxide-based active materials such as lithium titanate; and metallic lithium and lithium alloys can be adopted. The negative electrode active material may be of one type used alone, or may be of two or more types used in combination. The negative electrode active material may be particulate, and the size thereof is not particularly limited. The particles of the negative electrode active material may be solid particles, or may be hollow particles. The particles of the negative electrode active material may be primary particles, or may be secondary particles of a plurality of agglomerated primary particles. The average particle size (D50) of the negative electrode active material particles, for example, may be 1 nm or more, 5 nm or more, or 10 nm or more, and may be 500 μm or less, 100 μm or less, 50 μm or less, or 30 μm or less. Alternatively, the negative electrode active material may be sheet-like (foil-like or membranous), such as a lithium foil. Specifically, the negative electrode active material layer 21 may consist of a sheet of negative electrode active material.

The negative electrode active material layer 21 can comprise the electrolyte solution 30 described below. The negative electrode active material layer 21, in addition to the electrolyte solution 30, may comprise an additional electrolyte. Examples of the additional electrolyte include the above solid electrolytes, electrolyte solutions, and combinations thereof. The conductive aid that can be contained in the negative electrode active material layer 21, for example, needs only to be appropriately selected from among those exemplified as a conductive aid that can be contained in the above positive electrode active material layer 11. The binder that can be contained in the negative electrode active material layer 21, for example, needs only to be appropriately selected from among those exemplified as a binder that can be contained in the above positive electrode active material layer 11. The electrolyte, the conductive aid, and the binder may each be of one type used alone, or may be of two or more types used in combination.

### 1.2.2 Negative Electrode Current Collector

As shown in FIG. 1, the negative electrode 20 may comprise a negative electrode current collector 22 in contact with the negative electrode active material layer 21 and the electrolyte solution 30. For the negative electrode current collector 22, any general negative electrode current collector for batteries can be adopted. The negative electrode current collector 22 may be foil-like, tabular, mesh-like, punched metal-like, or a foam. The negative electrode current collector 22 may be a metal foil or a metal mesh, and alternatively, may be a carbon sheet. Particularly, a metal foil has excellent handleability. The negative electrode current collector 22 may consist of a plurality of foils or sheets. Metals constituting the negative electrode current collector 22 include Cu, Ni, Cr, Au, Pt, Ag, Al, Fe, Ti, Zn, Co, and stainless steel. From the viewpoint of ensuring reduction resistance and the viewpoint of making alloying with lithium difficult, the negative electrode current collector 22 may comprise at least one metal selected from Cu, Ni, and stainless steel. Alternatively, as described above, the negative electrode 20 may comprise an aluminum-containing current collector as a negative electrode current collector 22 in contact with the negative electrode active material layer 21 and the electrolyte solution 30. The negative electrode current collector 22 may comprise, on the surface thereof, some coating layer for the purpose of adjusting resistance. The negative electrode current collector 22 may be a metal foil or a substrate plated or vapor-deposited with a metal described above. When the negative electrode current collector 22 consists of a plurality of metal foils, there may be some layer between the plurality of metal foils. The thickness of the negative electrode current collector 22 is not particularly limited, and for example, may be 0.1 μm or more or 1 μm or more, and may be 1 mm or less or 100 μm or less.

The negative electrode 20, in addition to the above configurations, may comprise any general configuration as a negative electrode for lithium-ion batteries, for example, tabs or terminals. The negative electrode 20 can be manufactured by applying a known method. For example, the negative electrode active material layer 21 can be easily formed by molding a negative electrode mixture comprising the above components in a dry method or a wet method. The negative electrode active material layer 21 may be molded with the negative electrode current collector 22, or may be molded separately from the negative electrode current collector 22.

### 1.3 Electrolyte Solution

The electrolyte solution 30 comprises an organic solvent and a lithium amide slat dissolved in the organic solvent.

### 1.3.1 Organic Solvent

The electrolyte solution 30 comprises an organic solvent. For the organic solvent, any known organic solvent used in an electrolyte solution for lithium-ion batteries can be adopted. Regardless of the organic solvent used, a film 50 can be formed on the surface of the aluminum-containing current collector by the lithium amide salt described below, whereby elution of aluminum from the aluminum-containing current collector into the electrolyte solution 30 can be suppressed. The organic solvent, for example, may be a sulfone, may be a carbonate, may be a carboxylate ester, or may be a combination thereof.

The sulfone comprises a sulfonyl group (—S(═O)₂—). The sulfone may be a cyclic sulfone or a linear sulfone. The sulfone needs only to be one that is a liquid at the temperature at which lithium-ion conducting properties are desired to be exhibited and that can dissolve a lithium amide salt. When a sulfone as an organic solvent is contained in the electrolyte solution 30, it is considered that the transport number of lithium ions is improved by a mechanism similar to hopping conduction via the O site of the sulfonyl group. In addition, it is considered that together with the lithium amide salt described below, the sulfone contributes to formation of the film 50, and stability of the film 50 is increased. Particularly, when the electrolyte solution 30 comprises a cyclic sulfone, especially sulfolane, as an organic solvent, the transport number is likely to be further improved. The sulfone as an organic solvent may be of one type used alone, or may be of two or more types used in combination. The amount of the sulfone as an organic solvent contained in the electrolyte solution 30, when the entirety of the organic solvent is 100 mol %, may be 50 mol % or greater, 60 mol % or greater, 70 mol % or greater, 80 mol % or greater, 90 mol % or greater, 95 mol % or greater, 97 mol % or greater, or 99 mol % or greater.

The carbonate comprises a carbonate group (—O—(C═O)—O—). The carbonate may be a cyclic carbonate or a linear carbonate. The carbonate needs only to be one that is a liquid at the temperature at which lithium-ion conducting properties are desired to be exhibited and that can dissolve a lithium amide salt. Particularly, cyclic carbonates have a higher dielectric constant and are more likely to be coordinated with lithium ions, compared to linear carbonates. In other words, when the electrolyte solution 30 comprises a cyclic carbonate as an organic solvent, the cyclic carbonate is less likely to be in a free state, and as a result, thermal stability is likely to be improved. Specific examples of the cyclic carbonate include propylene carbonate (PC), ethylene carbonate (EC), butylene carbonate (BC), vinylene carbonate (VC), and derivatives (for example, halides) thereof. Particularly, when the cyclic carbonate is at least one of propylene carbonate and ethylene carbonate, more excellent lithium-ion conducting properties and thermal stability are likely to be ensured. Examples of the linear carbonate include dimethyl carbonate (DMC), diethyl carbonate (DEC), and derivatives (for example, halides, particularly those having a perfluoroalkyl group) thereof. However, linear carbonates tend to have a lower electric constant and be less likely to be coordinated with lithium ions, compared to cyclic carbonates. The carbonate as an organic solvent may be of one type used alone, or may be of two or more types used in combination. The amount of the carbonate as an organic solvent contained in the electrolyte solution 30, when the entirety of the organic solvent is 100 mol %, may be 50 mol % or greater, 60 mol % or greater, 70 mol % or greater, 80 mol % or greater, 90 mol % or greater, 95 mol % or greater, 97 mol % or greater, or 99 mol % or greater.

The carboxylate ester comprises an ester group (—(C═O)—O—). The carboxylate ester as an organic solvent can have a function of dissociating lithium ions from the lithium amide salt described below by the action of the ester group. In addition, the carboxylate ester as an organic solvent can have a function of lowering viscosity of the electrolyte solution 30. Therefore, when the electrolyte solution 30 comprises a carboxylate ester as an organic solvent, ionic conductivity of the electrolyte solution 30 is likely to be improved. The carboxylate ester may be a monocarboxylate ester, or may be a polycarboxylate ester such as a dicarboxylate ester or a tricarboxylate ester. Particularly, when the electrolyte solution 30 comprises a monocarboxylate ester as an organic solvent, ionic conductivity of the electrolyte solution 30 is likely to be significantly improved. The carboxylate ester may be an aliphatic carboxylate ester, or may be an aromatic carboxylate ester. Particularly, when the electrolyte solution 30 comprises an aliphatic carboxylate ester as an organic solvent, ionic conductivity of the electrolyte solution 30 is likely to be significantly improved. Particularly, when the electrolyte solution 30 comprises a carboxylate ester represented by formula (1) below as an organic solvent, ionic conductivity of the electrolyte solution 30 is particularly likely to be significantly improved.

R¹—(C═O)—O—R² (1)
R¹: a hydrocarbon group having 1 to 4 carbon atoms, for example, an alkyl group having 1 to 4 carbon atoms
R²: a hydrocarbon group having 1 to 4 carbon atoms, for example, an alkyl group having 1 to 4 carbon atoms

In the above formula (1), when R¹ is an alkyl group having 1 to 3 carbon atoms, especially an alkyl group having 2 or 3 carbon atoms, ionic conductivity of the electrolyte solution 30 is likely to be significantly improved. In the above formula (1), when R² is an alkyl group having 1 to 3 carbon atoms, especially an alkyl group having 1 or 2 carbon atoms, ionic conductivity of the electrolyte solution 30 is likely to be significantly improved. In the above formula (1), the total number of carbon atoms of R¹ and carbon atoms of R², for example, may be 2 or greater and 6 or less, may be 3 or greater and 5 or less, or may be 3 or 4. Specific examples of carboxylate esters include ethyl formate, methyl isobutyrate, methyl acetate, and methyl propionate. Particularly, when the electrolyte solution 30 comprises methyl propionate as an organic solvent, ionic conductivity of the electrolyte solution 30 is likely to be significantly improved.

The electrolyte solution 30 may comprise both of the above carbonate and carboxylate ester. In this case, ionic conductivity of the electrolyte solution 30 is likely to be further significantly improved. For example, the electrolyte solution 30 may comprise a carbonate as an organic solvent and a carboxylate ester as an organic solvent, the ratio of carbonate to all organic solvents contained in the electrolyte solution 30 may be 5% by volume or greater and 95% by volume or less, 5% by volume or greater and 50% by volume or less, or 10% by volume or greater and 20% by volume or less, the ratio of carboxylate ester to all organic solvents contained in the electrolyte solution 30 may be 5% by volume or greater and 95% by volume or less, 50% by volume or greater and 95% by volume or less, or 80% by volume or greater and 90% by volume or less, and the ratio of the total of carbonate and carboxylate ester to all organic solvents contained in the electrolyte solution 30 may be 50% by volume or greater and 100% by volume or less, 75% by volume or greater and 100% by volume or less, or 90% by volume or greater and 100% by volume or less.

The electrolyte solution 30 may comprise an additional organic solvent. Examples of the additional organic solvent include ethers. The amount of an ether as an organic solvent contained in the electrolyte solution 30, when the entirety of the organic solvent is 100 mol %, may be 5 mol % or less, 3 mol % or less, or 1 mol % or less. Alternatively, the electrolyte solution 30 may not comprise any ether.

### 1.3.2 Lithium Amide Salt

The electrolyte solution 30 comprise a lithium amide salt dissolved in the above organic solvent. In the electrolyte solution 30, the lithium amid salt may be dissolved in the organic solvent and ionized into cations and anions, or may form some association. Note that “amide salt” in the present application is a concept that includes “imide salt”.

### 1.3.2.1 LiCFSA

The lithium amide salt comprises LiCFSA (lithium 1,1,2,2,3,3-hexafluoropropane-1,3-disulfonimide) represented by formula (1) above. According to new findings of the present inventors, when an electrolyte solution 30 having LiCFSA dissolved therein is used to configure a lithium-ion battery 100 and the lithium-ion battery 100 is charged and discharged, a film 50 derived from LiCFSA can be formed on the surface of the aluminum-containing current collector. For example, up to the point where the electric potential of the aluminum-containing current collector reaches about 4.0 V (vs. Li/Li⁺), CFSA anions are adsorbed onto the surface of the aluminum-containing current collector, and a film 50 derived from the CFSA anions can be formed. When the CFSA anions are adsorbed onto the surface of the aluminum-containing current collector to form a film 50 derived from the CFSA anions, the film 50 comprises Al(CFSA)ₓ. “Al(CFSA)ₓ” means that Al derived from an aluminum-containing current collector and a CFSA anion derived from LiCFSA are adsorbed and bonded to each other. The value of x is not particularly limited. When a film 50 comprising Al(CFSA)ₓ is formed on the surface of the aluminum-containing current collector, the film 50 functions as a protective film, and even when the aluminum-containing current collector is at a high electric potential, elution of aluminum from the aluminum-containing current collector into the electrolyte solution 30 can be suppressed. Note that whether or not the film formed on the aluminum-containing current collector comprises Al(CFSA)ₓ can be confirmed by, for example, X-ray photoelectron spectroscopy (XPS).

As an electrolyte solution for lithium-ion batteries, a solution in which LiPF₆ as a lithium salt is dissolved in an organic solvent is known. As far as the present inventors have confirmed, LiPF₆ decomposes at a high electric potential, thereby allowing a film consisting of a fluoride to form on a surface of a current collector. According to new findings of the present inventors, when a film derived from LiPF₆ is formed on a surface of a current collector, there is a problem where decomposition of the electrolyte solution occurs and gas is generated simultaneously. In the lithium-ion battery 100 of the present disclosure, since LiCFSA is dissolved in the electrolyte solution 30, up to the point where the electric potential of the aluminum current collector reaches about 4.0 V (vs. Li/Li⁺), CFSA anions can be adsorbed onto the surface of the aluminum-containing current collector to form a film 50. Up to the point where the electric potential of the aluminum current collector reaches about 4.0 V (vs. Li/Li⁺), decomposition of the electrolyte solution 30 is unlikely to occur. Specifically, it can be said that in the lithium-ion battery 100 of the present disclosure, a film 50 can be formed on the surface of the aluminum-containing current collector while suppressing decomposition of the electrolyte solution 30 and suppressing generation of gas.

The concentration of LiCFSA in the electrolyte solution 30 is not particularly limited, and regardless of a low concentration or a high concentration, the above film 50 is formed on the surface of the aluminum-containing current collector, and an aluminum elution suppressing effect is demonstrated. The molar ratio ([LiCFSA (mol)]/[organic solvent (mol)]) of LiCFSA relative to the organic solvent, for example, may be 0.01 or greater and 0.50 or less, 0.05 or greater and 0.40 or less, or 0.10 or greater and 0.33 or less. In other words, LiCFSA may be dissolved at a concentration of 0.01 mol or more and 0.50 mol or less, 0.05 mol or more and 0.40 mol or less, or 0.10 mol or more and 0.33 mol or less per mol of organic solvent. When the concentration of LiCFSA dissolved in the organic solvent is in this range, the above aluminum elution suppressing effect is further enhanced and the electrolyte solution 30 is likely to have excellent ion-conducting properties. The molar ratio of LiCFSA relative to the organic solvent can be identified by analyzing the ions and elements contained in the organic solvent. 1.3.2.2 Additional lithium amide salt

The electrolyte solution 30 needs only to have the above LiCFSA dissolved therein, and may comprise the above LiCFSA and a lithium amide salt other than LiCFSA. The lithium amide salt other than LiCFSA may be a linear lithium amide salt, or may be a cyclic lithium amide salt other than LiCFSA. Specific examples of the linear lithium amide salt include sulfonylamide salts such as lithium bisfluorosulfonylamide (LiFSA, LiN(SO₂F)₂), lithium bistrifluoromethanesulfonylamide (LiTFSA, Li[N(CF₃SO₂)₂]), lithium bisperfluoroethylsulfonylamide (Li[N(C₂F₅SO₂)₂]), lithium bisperfluorobutylsulfonylamide (Li[N(C₄F₉SO₂)₂]), and lithium fluorosulfonyltrifluoromethanesulfonylamide (Li[N(FSO₂)(C₂F₅SO₂)]). Alternatively, silylamide salts having S substituted with Si may be adopted. The linear lithium amide salt may be of one type used alone, or may be of two or more types used in combination. Specific examples of the cyclic lithium amide salt other than LiCFSA include those in the above sulfonylamide salts and silylamide salts, where a sulfonylamide group forms a ring with another sulfonylamide group and a silylamide group forms a ring with another silylamide group via perfluoroalkylene groups. The concentration of the additional lithium amide salt in the electrolyte solution 30 is not particularly limited, and may be a low concentration or a high concentration. In the electrolyte solution 30, the ratio of LiCFSA to the lithium amide salt dissolved in the solvent may be high. Specifically, the ratio of LiCFSA to the entirety (100 mol %) of the lithium amide salt may be 50 mol % or greater, 60 mol % or greater, 70 mol % or greater, 80 mol % or greater, 90 mol % or greater, 95 mol % or greater, or 99 mol % or greater. Alternatively, in the electrolyte solution 30, the ratio of LiCFSA to the lithium amide salt dissolved in the solvent may be low. Specifically, the ratio of LiCFSA to the entirety (100 mol %) of the lithium amide salt may be 50 mol % or less, 40 mol % or less, 30 mol % or less, or 20 mol % or less.

### 1.3.3 Lithium Salt Other Than Lithium Amide Salt

In the electrolyte solution 30, the lithium salt dissolved in the organic solvent may consist of the above lithium amide salt, or may be a combination of the above lithium amide salt and a lithium salt other than a lithium amide salt (additional lithium salt). In the electrolyte solution 30, the ratio of lithium amide salt to the lithium salt dissolved in the solvent may be high. Specifically, the ratio of lithium amide salt to the entirety (100 mol %) of the lithium salt may be 50 mol % or greater, 60 mol % or greater, 70 mol % or greater, 80 mol % or greater, 90 mol % or greater, 95 mol % or greater, or 99 mol % or greater. Alternatively, in the electrolyte solution 30, the ratio of lithium amide salt to the lithium salt dissolved in the solvent may be low. Specifically, the ratio of lithium amide salt to the entirety (100 mol %) of the lithium salt may be 50 mol % or less, 40 mol % or less, 30 mol % or less, or 20 mol % or less.

### 1.3.4 Additional Optional Components

The electrolyte solution 30 may comprise various additives in ranges that allow the above object to be achieved, in addition to the organic solvent and the lithium amide salt. The types of additives can be appropriately selected in accordance with target performance. The electrolyte solution 30 may be combined with a solid material (for example, a solid electrolyte).

### 1.4 Film

As described above, in the lithium-ion battery 100, one or both of the positive electrode 10 and the negative electrode 20 comprise an aluminum-containing current collector, and the aluminum-containing current collector comprises, on a surface in contact with the electrolyte solution 30, a film 50 comprising Al(CFSA)ₓ. As described above, the film 50 may be formed by adsorbing CFSA anions onto the surface of the aluminum-containing current collector up to the point where the electric potential of the aluminum-containing current collector reaches about 4.0 V (vs. Li/Li⁺). In addition, according to new findings of the present inventors, in the lithium-ion battery 100, a film 50 comprising Al(CFSA)ₓ and aluminum fluoride can be formed on the surface of the aluminum-containing current collector up to the point where the electric potential of the aluminum-containing current collector reaches about 6.0 V (vs. Li/Li⁺). Specifically, the film 50 may comprise aluminum fluoride. As such, the film 50 comprising Al(CFSA)ₓ and aluminum fluoride can suppress elution of aluminum from the aluminum-containing current collector into the electrolyte solution 30. Alternatively, the film 50 may comprise Al(CFSA)ₓ and comprise no aluminum fluoride. As described above, even if the film 50 comprises Al(CFSA)ₓ alone, elution of aluminum from the aluminum-containing current collector into the electrolyte solution 30 can be suppressed. Note that whether or not the film formed on the surface of the aluminum-containing current collector comprises Al(CFSA)ₓ and aluminum fluoride (AlFₓ) can be confirmed by, for example, X-ray photoelectron spectroscopy (XPS).

The film 50, as shown in FIG. 1, may be formed on the surface of an aluminum-containing current collector as the positive electrode current collector 12. Alternatively, the film 50 may be formed on the surface of an aluminum-containing current collector as the negative electrode current collector 22. Alternatively, the film 50, may be formed on the surfaces of both of an aluminum-containing current collector as the positive electrode current collector 12 and an aluminum-containing current collector as the negative electrode current collector 22. Particularly, when the film 50 is at least formed on the surface of an aluminum-containing current collector as the positive electrode current collector 12, a greater effect is likely to be achieved. The thickness of the film 50 is not particularly limited. The thickness of the film 50, for example, may be more than 0 μm and 10 μm or less. Alternatively, the thickness of the film 50, for example, may be more than 10 μm. Particularly, when the thickness of the film 50 is more than 0 μm and 10 μm or less, the above aluminum elution suppressing effect is likely to be ensured, while a satisfactory balance of other battery performances is likely to be achieved. The film 50 may be formed on the entirety of the surface where the aluminum-containing current collector and the electrolyte solution 30 are in contact, or may be formed on a portion thereof.

### 1.5 Additional Configurations

The lithium-ion battery 100 may comprise a separator 40 between the positive electrode 10 and the negative electrode 20, and the above electrolyte solution 30 may be retained in the separator 40. For the separator 40, any known separator can be adopted as a separator in the lithium-ion battery 100. In the lithium-ion battery 100, the above components may be housed inside an outer packaging. Any known outer packaging can be adopted as the outer packaging of the battery. A plurality of lithium-ion batteries 100 may be optionally electrically connected and optionally stacked to form a battery pack. In this case, the battery pack may be housed inside any known battery case. The lithium-ion battery 100 may comprise additional obvious components such as the necessary terminals. Examples of shapes of the lithium-ion battery 100 can include coin-type, laminate-type, cylindrical, and rectangular. The lithium-ion battery 100 may be a secondary battery. The lithium-ion battery 100 can be manufactured by applying a known method, for example, can be manufactured as follows. However, the method for manufacturing the lithium-ion battery 100 is not limited to the following method. For example, each layer may be formed by dry molding.
(1) A positive electrode active material constituting a positive electrode active material layer is dispersed in a solvent to obtain a positive electrode slurry. The solvent used in this case is not particularly limited, and water and various organic solvents can be used. The positive electrode slurry is applied onto a surface of a positive electrode current collector using a doctor blade, followed by drying, whereby a positive electrode active material layer is formed on the surface of the positive electrode current collector to obtain a positive electrode.
(2) A negative electrode active material constituting a negative electrode active material layer is dispersed in a solvent to obtain a negative electrode slurry. The solvent used in this case is not particularly limited, and water and various organic solvents can be used. The negative electrode slurry is applied onto a surface of a negative electrode current collector using a doctor blade, followed by drying, whereby a negative electrode active material layer is formed on the surface of the negative electrode current collector to obtain a negative electrode.
(3) Layers are layered so that an electrolyte layer (separator) is sandwiched by the negative electrode and the positive electrode to obtain a layered body comprising, in the order of, a negative electrode current collector, a negative electrode active material layer, an electrolyte layer, a positive electrode active material layer, and a positive electrode current collector. Additional members such as terminals are attached to the layered body as needed.
(4) The layered body is housed in a battery case, the layered body is immersed in an electrolyte solution, and the layered body is sealed within the battery case, thereby obtaining a lithium-ion battery. Note that the electrolyte solution may be contained in the negative electrode active material layer, the separator, and the positive electrode active material layer in step (3) above.

### 2. Lithium-Ion Conducting Material

The technique of the present disclosure has an aspect as a lithium-ion conducting material. Specifically, the lithium-ion conducting material of the present disclosure comprises an organic solvent and a lithium amide salt dissolved in the organic solvent, and the lithium amide salt comprises LiCFSA represented by the above formula (1). Details of each component constituting the lithium-ion conducting material are as described above.

### 3. Vehicle

The lithium-ion battery of the present disclosure, for example, can be suitably used in at least one type of vehicle selected from hybrid vehicle (HEV), plug-in hybrid vehicle (PHEV), and battery electric vehicle (BEV). Specifically, the technique of the present disclosure has an aspect as a vehicle provided with a lithium-ion battery, wherein the lithium-ion battery comprises a positive electrode, a negative electrode, and an electrolyte solution, the electrolyte solution comprises an organic solvent and a lithium amide salt dissolved in the organic solvent, the lithium amide salt comprises LiCFSA represented by the above formula (1), one or both of the positive electrode and the negative electrode comprise an aluminum-containing current collector, the aluminum-containing current collector comprises, on a surface in contact with the electrolyte solution, a film, and the film comprises Al(CFSA)ₓ.

### EXAMPLES

Hereinafter, the technique of the present disclosure will be further described in detail with reference to the Examples. However, the technique of the present disclosure is not limited to the following Examples. Note that all of the following experiments are carried out under an Ar atmosphere having a dew point of −80° C. or lower and an oxygen concentration of less than 3 ppm, in a glove box or an equivalent environment not exposed to ambient air.

### 1. Production of Electrolyte Solution

### 1.1 Comparative Example 1

An LBG electrolyte solution manufactured by Kishida Chemical Co., Ltd. was prepared as an electrolyte solution according to Comparative Example 1. The electrolyte solution according to Comparative Example 1 was obtained by dissolving LiPF₆ at a concentration of 1 M in a mixed organic solvent of ethylene carbonate (EC), ethyl methyl carbonate (EMC), and dimethyl carbonate (DMC).

### 1.2 Comparative Example 2

To achieve a molar ratio of lithium bis(fluorosulfonyl)amide (LiFSA) as a lithium amide salt relative to propylene carbonate (PC) as an organic solvent of 0.33 (PC:LiFSA=3:1), components were each weighed, and then mixed and stirred, thereby obtaining an electrolyte solution according to Comparative Example 2.

### 1.3 Comparative Example 3

To achieve a molar ratio of lithium bis(trifluoromethanesulfonyl)amide (LiTFSA) as a lithium amide salt relative to PC of 0.33 (PC:LiTFSA=3:1), components were each weighed, and then mixed and stirred, thereby obtaining an electrolyte solution according to Comparative Example 3.

### 1.4 Comparative Example 4

To achieve a molar ratio of LiFSA relative to sulfolane (SL, melting point of 27.8° C.) as an organic solvent of 0.10 (SL:LiFSA=10:1), components were each weighed, and then mixed and stirred, thereby obtaining an electrolyte solution according to Comparative Example 4.

### 1.5 Comparative Example 5

To achieve a molar ratio of LiFSA relative to SL of 0.33 (SL:LiFSA=3:1), components were each weighed, then mixed and stirred, thereby obtaining an electrolyte solution according to Comparative Example 5.

### 1.6 Example 1

To achieve a molar ratio of lithium 1,1,2,2,3,3-hexafluoropropane-1,3-disulfonimide (LiCFSA) as a lithium amide salt relative to SL of 0.10 (SL:LiCFSA=10:1), components were each weighed, then mixed and stirred, thereby obtaining an electrolyte solution according to Example 1.

### 1.7 Example 2

To achieve a molar ratio of LiCFSA relative to SL of 0.33 (SL:LiCFSA=3:1), components were each weighed, and then mixed and stirred, thereby obtaining an electrolyte solution according to Example 2. Note that the electrolyte solution according to Example 2 was a solid at room temperature (25° C.) but a liquid at 60° C., and therefore could be used as an electrolyte solution.

### 1.8 Example 3

To achieve a molar ratio of LiCFSA relative to PC of 0.10 (PC: LiCFSA=10:1), components were each weighed, and then mixed and stirred, thereby obtaining an electrolyte solution according to Example 3.

### 2. Evaluations of Ionic Conductivity and Transport Number

A two-electrode symmetrical cell using Li metal for the electrodes, using the various electrolyte solutions described above as the electrolyte solution, and having fixed electrode area and the interelectrode distance was prepared, and resistance value was measured at 25° C. by an alternating current impedance method. From the obtained resistance value and cell shape (electrode area and interelectrode distance), ionic conductivity was calculated. In addition, transport number was calculated by the Bruce method, which is a combination of direct current polarization and impedance methods. The impedance measurement conditions and direct current polarization measurement conditions were as follows.

Impedance measurement conditions: temperature of 25° C., amplitude of 10 mV, and frequency of 1 M to 10 mHz

Direct current polarization measurement conditions: temperature of 25° C., applied voltage of 10 mV, and retention time of 10 h

### 3. Al corrosivity evaluation

An Al foil as the working electrode, Li metal as the counter electrode, and each of the electrolyte solutions according to the above Examples and Comparative Examples were used to produce a half-cell, and the presence or absence of Al elution into the electrolyte solution (Al corrosivity) was evaluated by cyclic voltammetry (CV measurement). Specific measurement conditions were as follows.

Measurement conditions: sweep rate of 10 mV/s, OCV→(6 V→3 V), and number of cycles: 5 cycles

### 4. Analysis of Film on Al Foil by XPS

### 4.1 Regarding Film After Maintaining at 4 V

An Al foil as the working electrode, Li metal as the counter electrode, and each of the electrolyte solutions according to the above Examples 1 to 3 and Comparative Example 1 were used to produce a half-cell. The half-cell was maintained at 4 V, the Al foil was then recovered from the half-cell and washed with dimethyl ether (DME), and the Al foil surface was then analyzed by XPS.

### 4.2 Regarding Film After Maintaining at 6 V

An Al foil as the working electrode, Li metal as the counter electrode, and each of the electrolyte solutions according to the above Examples 1 and 3 were used to produce a half-cell. The half-cell was maintained at 6 V, the Al foil was then recovered from the half-cell and washed with dimethyl ether (DME), and the Al foil surface was then analyzed by XPS.

### 5. Evaluation Results

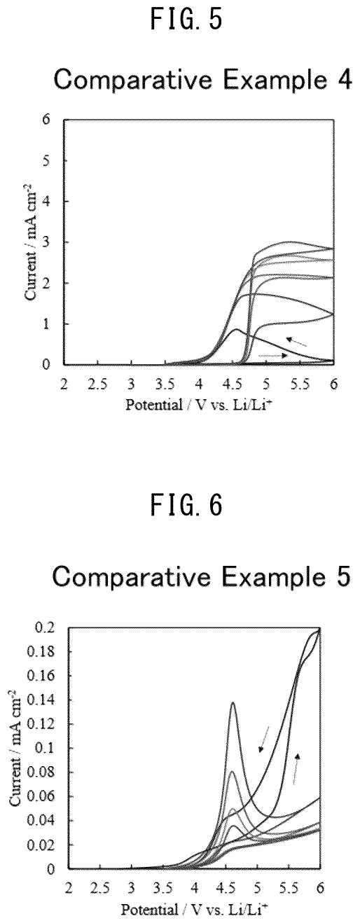

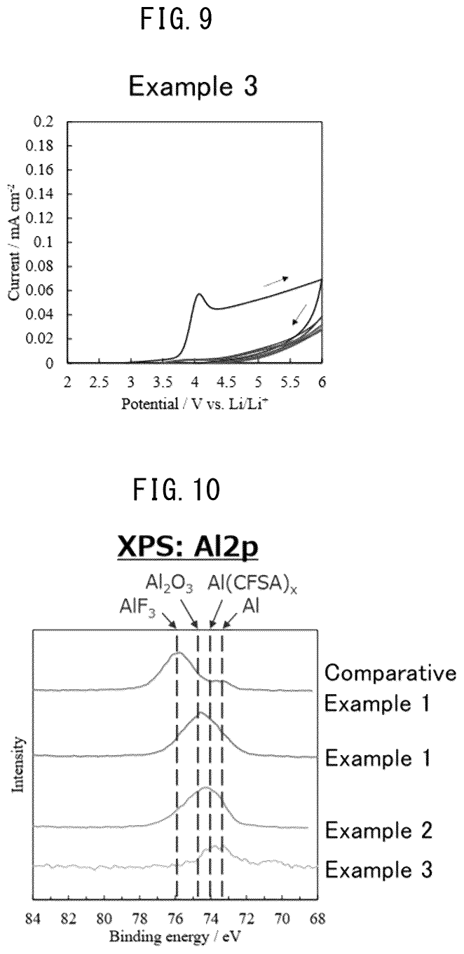

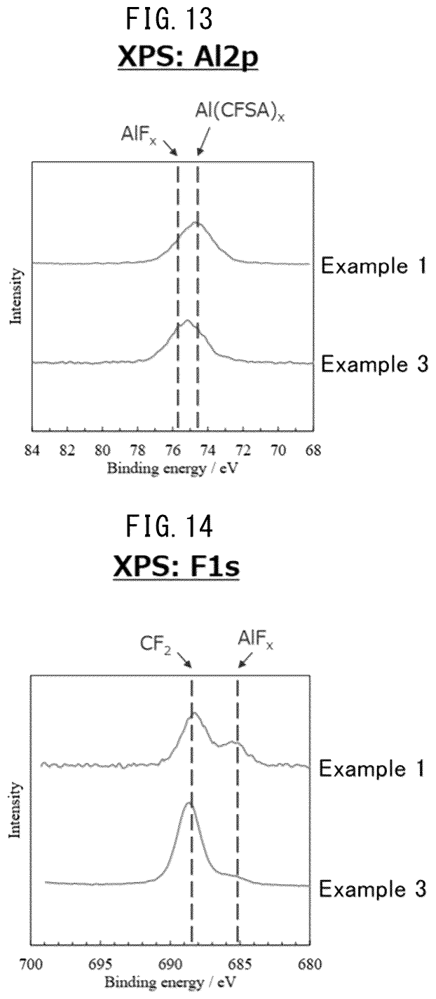

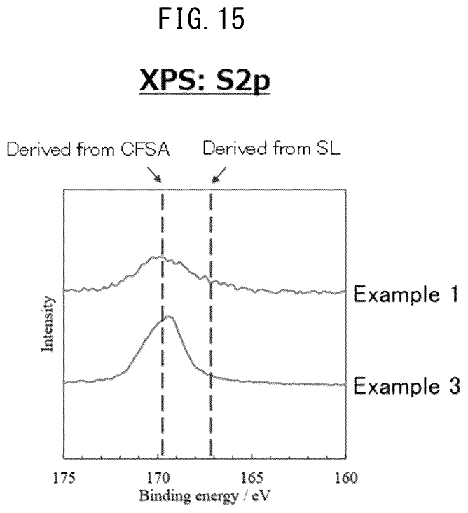

In Table 1 below, the composition, ionic conductivity, transport number, presence of Al corrosion behavior, and components contained in the film formed on the Al foil surface of each of the electrolyte solutions according to Examples 1 to 3 and Comparative Examples 1 to 5 are shown. In FIGS. 2 to 9, CV measurement results of each of Comparative Examples 1 to 5 and Examples 1 to 3 are shown. In FIGS. 10 to 12, XPS analysis results of the film formed on the Al foil surface after maintaining at 4 V for each of Comparative Example 1 and Examples 1 to 3 are shown. In FIGS. 13 to 15, XPS analysis results of the film formed on the Al foil surface after maintaining at 6 V for each of Examples 1 and 3 are shown.

TABLE 1

| | | | | | Film | Film |
|---|---|---|---|---|---|---|
| | | | | | component | component |
| | | | | | when | when |
| | Electrolyte | Ionic | | Presence of | maintained | maintained |
| | solution | conductivity | Transport | Al corrosion | at 4 V | at 6 V |
| | composition | [S/cm] | number | behavior | (thickness) | (thickness) |
| Comparative | 1M LiPF6 | 2.6E−03 | 0.30 | No | AlFx | No data |
| Example 1 | (EC/EMC/DMC) | | | | (>20 μm) | |
| Comparative | PC/LiFSA = 3/1 | 2.6E−03 | 0.74 | Yes | Analysis not | Analysis not |
| Example 2 | | | | | possible due to | possible due to |
| | | | | | corrosion | corrosion |
| Comparative | PC/LiTFSA = 3/1 | 1.3E−03 | 0.64 | Yes | Analysis not | Analysis not |
| Example 3 | | | | | possible due to | possible due to |
| | | | | | corrosion | corrosion |
| Comparative | SL/LiFSA = 10/1 | 4.1E−03 | 0.75 | Yes | Analysis not | Analysis not |
| Example 4 | | | | | possible due to | possible due to |
| | | | | | corrosion | corrosion |
| Comparative | SL/LiTFSA = 3/1 | 3.2E−03 | 0.78 | Yes | Analysis not | Analysis not |
| Example 5 | | | | | possible due to | possible due to |
| | | | | | corrosion | corrosion |
| Example 1 | SL/LiCFSA = 10/1 | 2.5E−03 | 0.76 | No | Al(CFSA)x | Al(CFSA)x, |
| | | | | | (0 to 10 μm) | AlFx |
| | | | | | | (20 to 30 μm) |
| Example 2 | SL/LiCFSA = 3/1 | 7.9E−07 | 0.91 | No | Al(CFSA)x | No data |
| | | (solid) | | | (0 to 10 μm) | |
| Example 3 | PC/LiCFSA = 10/1 | 5.7E−03 | 0.47 | No | Al(CFSA)x | Al(CFSA)x, |
| | | | | | (>10 μm) | AlFx |
| | | | | | | (20 to 30 μm) |

The following was found from the results shown in Table 1 and FIGS. 2 to 12.

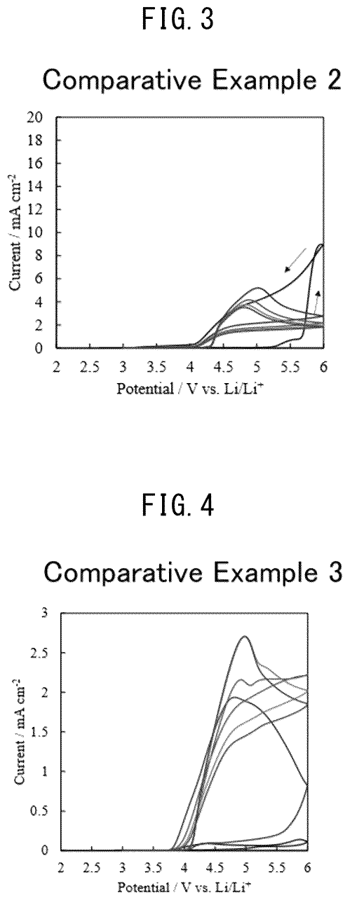

As shown in FIGS. 3 to 6, in the CV measurements of Comparative Examples 2 to 5, current value increased during electric potential scanning in the negative direction after turnaround at 6 V, compared to that during electric potential scanning in the positive direction to 6 V, meaning that the Al foil was corroded and Al was eluted into the electrolyte solution.

As shown in FIGS. 2 and 7 to 9, in CV measurements of Comparative Example 1 and Examples 1 to 3, current value decreased during electric potential scanning in the negative direction after turnaround at 6 V, compared to that during electric potential scanning in the positive direction to 6 V, meaning that elution of Al into the electrolyte solution was suppressed.

As shown in FIG. 2, in CV measurement of Comparative Example 1, wherein LiPF₆ was used, an increase in current was confirmed from around 3 V in the first cycle, and a peak top was confirmed at around 3.7 V. From the results of analysis of the film on the Al foil by XPS shown in FIGS. 10 to 12, the peak top around 3.7 V was considered to correspond to the decomposition current of LiPF₆, and it was found that a film comprising aluminum fluoride (AlFₓ) was formed on the surface of the Al foil by the decomposition of LiPF₆. In Comparative Example 1, gas was generated due to decomposition of LiPF₆ during film formation, and a process and mechanism for releasing the gas from within the cell were required. If gas accumulated within the cell, performance of the cell may deteriorate due to reduction in conduction paths and reaction area.

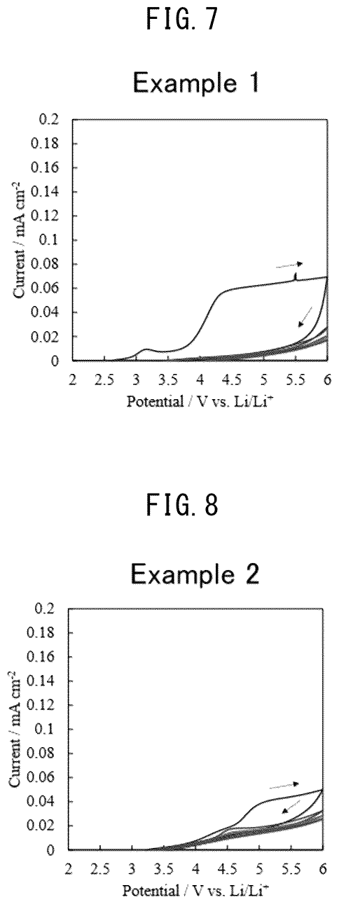

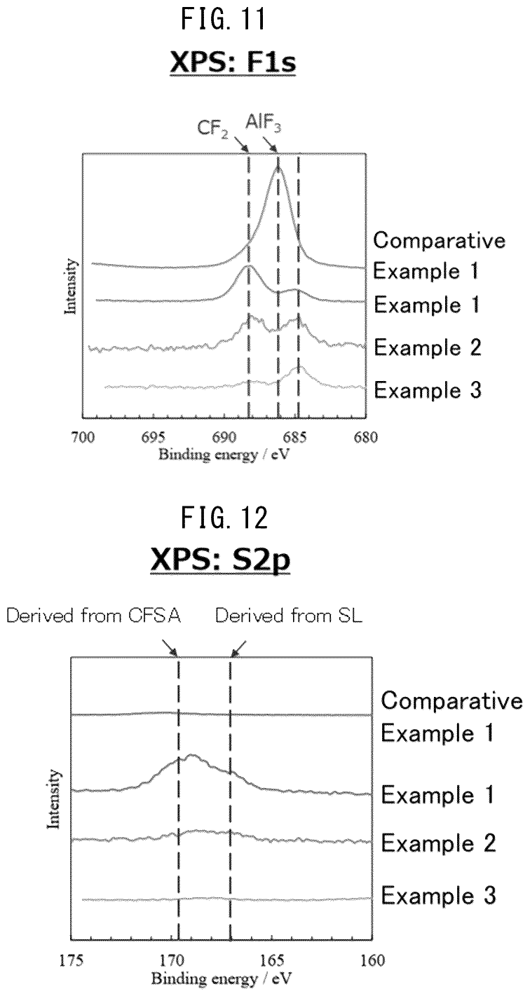

As shown in FIGS. 7 to 9, in CV measurements of Examples 1 to 3, wherein LiCFSA was used, no increase in current was confirmed up to around 3.7 V. From the results of analysis of the film on the Al foil by XPS shown in FIGS. 10 to 12, although no AlFₓ on the surface of the Al foil was confirmed, a film resulting from adsorption of CFSA anions was confirmed. Specifically, as shown in FIG. 10, in Examples 1 to 3, a film comprising Al(CFSA)ₓ was formed on the surface of the Al foil. In FIG. 10, Al₂O₃ present (under the film) on the surface of the Al foil was also detected, and it was found that the film comprising Al(CFSA)ₓ was a thin film of 10 μm or less. Further, as shown in FIG. 11, in Examples 1 to 3, the film on the surface of the Al foil had CF₂ bonds. This resulted from the above CFSA anions. Also from FIG. 12, in Examples 1 to 3, it was found that a film derived from CFSA anions was formed on the surface of the Al foil. Specifically, when any of the electrolyte solutions according to Examples 1 to 3 was used to configure a lithium-ion battery, a film (film comprising Al(CFSA)ₓ) resulting from adsorption of CFSA anions could be formed on the surface of the A1 foil without substantially causing decomposition of the electrolyte solution (solvent and lithium salt) at up to 4 V, whereby it can be said that Al corrosion could be suppressed. In other words, in Examples 1 to 3, the decomposition reaction of the electrolyte solution did not occur during formation of the film comprising Al(CFSA)ₓ, and thus it can be said that gas generation during film formation, which was a problem in Comparative Example 1, could be suppressed.

From the results shown in Table 1 and FIGS. 13 to 15, the following was found. Specifically, in Examples 1 to 3, a relatively thick film comprising the above Al(CFSA)ₓ and aluminum fluoride (AlFₓ) was formed on the surface of the Al foil at up to 6 V. As described above, whereas Al corrosion occurred when LiFSA or LiTFSA was used alone as in Comparative Examples 2 to 5, it can be said that by using LiCFSA as in Examples 1 to 3, elution of Al was suppressed by the film even at a high electric potential of 6 V.

From the results shown in Table 1, it was found that a more excellent transport number can be ensured when a sulfone (for example, sulfolane) as an organic solvent is used than when a carbonate is used.

### 6. Summary

From the above results, according to a lithium-ion battery provided with the following configurations (1) to (3), it can be said that elution of aluminum from an aluminum-containing current collector into an electrolyte solution can be suppressed by a film on the surface of the aluminum-containing current collector. In addition, it can be said that when forming a film on the surface of the aluminum-containing current collector, decomposition of the electrolyte solution can be suppressed, and generation of gas can be suppressed.
(1) The lithium-ion battery comprises a positive electrode, a negative electrode, and an electrolyte solution.
(2) The electrolyte solution comprises an organic solvent and a lithium amide salt dissolved in the organic solvent, and the lithium amide salt comprises LiCFSA represented by the above formula (1).
(3) One or both of the positive electrode and the negative electrode comprise an aluminum-containing current collector, the aluminum-containing current collector comprises, on a surface in content with the electrolyte solution, a film, and the film comprises Al(CFSA)ₓ.

### 7. Further Examination of Organic Solvent Constituting Electrolyte Solution

### 7.1 Production of Electrolyte Solution

### 7.1.1 Comparative Example A

Ethylene carbonate (EC), ethyl methyl carbonate (EMC), and dimethyl carbonate (DMC) were mixed so as to have a volume ratio of 3:3:4 to obtain a mixed solvent. LiPF₆ as a lithium salt was mixed and stirred into the mixed solvent to a concentration of 1.15 M to obtain an electrolyte solution according to Comparative Example A.

### 7.1.2 Comparative Example B

Ethylene carbonate (EC) and diethyl carbonate (DEC) were mixed so as to have a volume ratio of 1:1 to obtain a mixed solvent. Lithium bis(fluorosulfonyl)amide (LiFSA) as a lithium amide salt was mixed and stirred into the mixed solvent to a concentration of 1 M to obtain an electrolyte solution according to Comparative Example B.

### 7.1.3 Example A

Ethylene carbonate (EC) and diethyl carbonate (DEC) were mixed so as to have a volume ratio of 1:1 to obtain a mixed solvent. Lithium bis(fluorosulfonyl)amide (LiFSA) and lithium 1,1,2,2,3,3-hexafluoropropane-1,3-disulfonimide (LiCFSA) as lithium amide salts, at a molar ratio of 0.8:0.2, were mixed and stirred into the mixed solvent to a total concentration of 1 M to obtain an electrolyte solution according to Example A.

### 7.1.4 Example B

Ethylene carbonate (EC) and diethyl carbonate (DEC) were mixed so as to have a volume ratio of 1:1 to obtain a mixed solvent. Lithium 1,1,2,2,3,3-hexafluoropropane-1,3-disulfonimide (LiCFSA) as a lithium amide salt was mixed and stirred into the mixed solvent to a concentration of 1 M to obtain an electrolyte solution according to Example B.

### 7.1.5 Comparative Example C

Ethylene carbonate (EC) and methyl propionate (MP) were mixed so as to have a volume ratio of 15:85 to obtain a mixed solvent. Lithium bis(fluorosulfonyl)amide (LiFSA) as a lithium amide salt was mixed and stirred into the mixed solvent to a concentration of 1 M to obtain an electrolyte solution according to Comparative Example C.

### 7.1.6 Example C

Ethylene carbonate (EC) and methyl propionate (MP) were mixed so as to have a volume ratio of 15:85 to obtain a mixed solvent. Lithium bis(fluorosulfonyl)amide (LiFSA) and lithium 1,1,2,2,3,3-hexafluoropropane-1,3-disulfonimide (LiCFSA) as lithium amide salts, at a molar ratio of 0.8:0.2, were mixed and stirred into the mixed solvent to a total concentration of 1 M to obtain an electrolyte solution according to Example C.

### 7.1.7 Example D

Ethylene carbonate (EC) and methyl propionate (MP) were mixed so as to have a volume ratio of 15:85 to obtain a mixed solvent. Lithium 1,1,2,2,3,3-hexafluoropropane-1,3-disulfonimide (LiCFSA) as a lithium amide salt was mixed and stirred into the mixed solvent to a concentration of 1 M to obtain an electrolyte solution according to Example D.

### 7.1.8 Example E

Ethylene carbonate (EC) and methyl propionate (MP) were mixed so as to have a volume ratio of 15:85 to obtain a mixed solvent. Lithium bis(fluorosulfonyl)amide (LiFSA) and lithium 1,1,2,2,3,3-hexafluoropropane-1,3-disulfonimide (LiCFSA) as lithium amide salts, at a molar ratio of 1.0:0.4, were mixed and stirred into the mixed solvent to a total concentration of 1.4 M to obtain an electrolyte solution according to Example E.

### 7.2 Al Corrosivity Evaluation

An Al foil as the working electrode, Li metal as the counter electrode, and each of the electrolyte solutions according to the above Examples A to E and Comparative Examples A to C were used to produce a half-cell, and the presence or absence of Al elution into the electrolyte solution (Al corrosivity) was evaluated by cyclic voltammetry (CV measurement). Specific measurement conditions were the same as the conditions described above.

### 7.3 Ionic Conductivity Evaluation

A two-electrode symmetrical cell using Li metal for the electrodes, using each of the electrolyte solutions according to the above Examples A to E and Comparative Examples A to C as the electrolyte solution, and having fixed electrode area and interelectrode distance was produced, and resistance value was measured at 25° C. by an alternating current impedance method. From the obtained resistance value and cell shape (electrode area and interelectrode distance), ionic conductivity was calculated. A two-electrode symmetrical cell having fixed electrode area and interelectrode distance was configured, and resistance value was measured at 25° C. by an alternating current impedance method. From the obtained resistance value and cell shape (electrode area and interelectrode distance), the ionic conductivity of the electrolyte solution was calculated. The impedance measurement conditions were the same as the conditions described above.

### 7.4 Evaluation Results

In Table 2 below, the presence of Al corrosion behavior and the measurement results of ionic conductivity for each of the electrolyte solutions according to Examples A to E and Comparative Examples A to C are shown.

TABLE 2

| | | Presence | |
|---|---|---|---|
| | | of Al | Ionic |
| | Electrolyte solution | corrosion | conductivity |
| | composition | behavior | [mS/cm] |
| Comparative | 1.15M LiPF6 | No | 14.8 |
| Example A | (EC/EMC/DMC = 3/3/4 vol.) | | |
| Comparative | 1M LiFSA | Yes | 11.4 |
| Example B | (EC/DEC = 1/1 vol.) | | |
| Example A | 1M LiFSA/LiCFSA = | No | 11.1 |
| | 0.8/0.2 mol | | |
| | (EC/DEC = 1/1 vol.) | | |
| Example B | 1M LiCFSA | No | 7.9 |
| | (EC/DEC = 1/1 vol.) | | |
| Comparative | 1M LiFSA | Yes | 21.4 |
| Example C | (EC/MP = 15/85 vol.) | | |
| Example C | 1M LiFSA/LiCFSA = | No | 17.1 |
| | 0.8/0.2 mol | | |
| | (EC/MP = 15/85 vol.) | | |
| Example D | 1M LiCFSA | No | 15.7 |
| | (EC/MP = 15/85 vol.) | | |
| Example E | 1.4M LiFSA/LiCFSA = | No | 19.8 |
| | 1.0/0.4 mol | | |
| | (EC/MP = 15/85 vol.) | | |

From the results shown in Table 2, it was found that the Al corrosion suppressing effect by including LiCFSA in the electrolyte solution is demonstrated regardless of the type of organic solvent constituting the electrolyte solution. It was also found that ionic conductivity of the electrolyte solution changes depending on the type of organic solvent. From the results shown in Table 2, it was found that when an electrolyte solution comprises a carboxylate ester as an organic solvent, ionic conductivity of the electrolyte solution is significantly improved.

### REFERENCE SIGNS LIST

10 positive electrode
   11 positive electrode active material layer
   12 positive electrode current collector
20 negative electrode
   21 negative electrode active material layer
   22 negative electrode current collector
30 electrolyte solution
40 separator
50 film
100 lithium-ion battery

1. A lithium-ion battery, comprising a positive electrode, a negative electrode, and an electrolyte solution, wherein
the electrolyte solution comprises
an organic solvent and
a lithium amide salt dissolved in the organic solvent,
the lithium amide salt comprises LiCFSA represented by formula (1) below,
one or both of the positive electrode and the negative electrode comprise an aluminum-containing current collector,
the aluminum-containing current collector comprises, on a surface in contact with the electrolyte solution, a film, and
the film comprises Al(CFSA)ₓ.

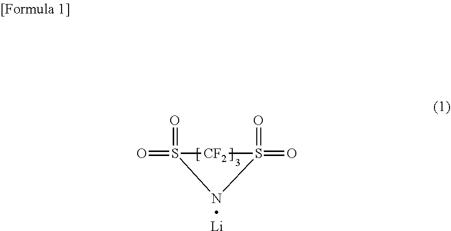

2. The lithium-ion battery according to claim 1, wherein
the electrolyte solution comprises sulfolane as the organic solvent.

3. The lithium-ion battery according to claim 1, wherein
the electrolyte solution comprises a carboxylate ester as the organic solvent.

4. The lithium-ion battery according to claim 1, wherein
the film comprises aluminum fluoride.

5. The lithium-ion battery according to claim 1. wherein
at least the positive electrode comprises the aluminum-containing current collector.
